(19) United States
(12) Patent Application Publication
(10) Pub. No.: US 2014/0028605 A1
(43) Pub. Date: Jan. 30, 2014

(54) Touch Profiling on Capacitive-Touch Screens

(71) Applicants: Chenchi Eric Luo, Atlanta, GA (US); Milind Borkar, Dallas, TX (US)

(72) Inventors: Chenchi Eric Luo, Atlanta, GA (US); Milind Borkar, Dallas, TX (US)

(73) Assignee: TEXAS INSTRUMENTS INCORPORATED, Dallas, TX (US)

(21) Appl. No.: 13/559,118

(22) Filed: Jul. 26, 2012

(51) Int. Cl. G06F 3/044

(52) U.S. Cl. 345/174

(57) ABSTRACT

An embodiment of the invention provides a method and apparatus for determining what type of interaction is made with a capacitive touch screen. A capacitance sensor with the largest sensed capacitance in a group of capacitance sensors is determined. Next, a parametric surface is determined from the value of the largest sensed capacitance and the values of the sensed capacitances in the group of capacitance sensors. From the parametric surface, an interpolated peak capacitance, a curvature K at the interpolated peak and an orientation θ at the interpolated peak are determined. Based on the interpolated peak capacitance, the curvature K and the orientation θ, the type of interaction made with the capacitive-touch screen is identified.

### BACKGROUND

The popularity of capacitive-touch screens has been increasing since the introduction of smart phones and tablet PCs (personal computers). Capacitive-touch screens are becoming larger in size and there is an increasing demand on the responsiveness, resolution and intelligence of these screens.

A capacitive-touch screen is usually composed of an array of capacitance sensors (also called nodes) where each capacitance sensor 100 (see FIG. 1) contains an electrical parasitic capacitance C_{P} (referred to as baseline capacitance thereafter). Making direct physical contact (e.g. a finger touch) or approximate physical contact (e.g. a palm near a screen) with a capacitance sensor 100 will add a second capacitance C_{F} (referred to as foreground capacitance thereafter) in parallel with C_{P} such that the overall sensed capacitance C_{S} developed for a touched sensor is C_{F}+C_{P}. Ideally, after measurement and calibration, the foreground capacitance C_{F} can be extracted from the sensed capacitance C_{S} (i.e. C_{F}=C_{S}−C_{P}).

Contact with a capacitance sensor 100 can be detected when the calibrated foreground capacitance C_{F} on specific node(s) is greater than a pre-determined threshold. By measuring the sensed capacitance C_{S} on each node, a two dimensional image of the change in capacitance may be constructed. This two dimensional image can be used to determine the location of the contact with the screen. The accuracy of the determination of the location where contact is made with the screen can be reduced due to noise caused during the measurement of the sensed capacitance C_{S}. In addition, there is more information associated with each contact made with the capacitive touch screen than just its location. For example, the two dimensional image may be used to identify a finger contact, stylus contact or a human palm or cheek in proximity to the capacitive touch screen.

A two dimensional surface modeling circuit may be used to model peaks introduced by contact with a capacitive touch screen. The analytic properties embedded in the peaks such as curvature (i.e. smoothness), orientation and coordinates of the peak may be used to improve the accuracy of determining location of contact on a capacitive touch screen and the type (e.g. finger, stylus, palm) of contact.

### BRIEF DESCRIPTION OF THE DRAWINGS

FIG. 1 is a diagram showing a cross-section of a sensor on a capacitive-touch screen along with capacitances on the capacitive-touch screen. (Prior Art)

FIG. 2 is a layout of a capacitive-touch screen indicating the locations of the capacitance sensors. (Prior Art)

FIG. 3 is a graph of change in capacitance in a sensor as result of two fingers making contact with a capacitive-touch screen. (Prior Art)

FIG. 4a is a schematic diagram of a voltage source charging a capacitor. (Prior Art)

FIG. 4b is a schematic diagram of a charged capacitor and an uncharged capacitor. (Prior Art)

FIG. 4c is a schematic diagram of a charge being transferred from one capacitor to another capacitor. (Prior Art)

FIG. 5 is a schematic diagram of a charge transfer circuit. (Prior Art)

FIG. 6 is a block diagram of an electronic device used to identify the type of contact made with a capacitive touch screen according to an embodiment of the invention.

FIG. 7 illustrates an example of a group of nine capacitance sensors where the peak capacitance CS is located at the center coordinate (0,0) of the eight adjacent capacitance sensors located at coordinates (−1, −1), (0, −1), (1,−1), (−1, 0), (1,0), (−1, 1), (0,1) and (1,1) according to an embodiment of the invention.

FIG. 8 is an example of a parametric surface showing an interpolated peak sensed capacitance, the curvature K of the interpolated peak and the orientation θ of the interpolated peak according to an embodiment of the invention.

FIG. 9 is an example of a parametric surface showing an interpolated peak sensed capacitance, the curvature K of the interpolated peak and the orientation θ of the interpolated peak indicating contact with a human finger according to an embodiment of the invention.

FIG. 10 is an example of a parametric surface showing an interpolated peak sensed capacitance, the curvature K of the interpolated peak and the orientation θ of the interpolated peak indicating interaction with a human palm according to an embodiment of the invention.

FIG. 11 is an example of a parametric surface showing an interpolated peak sensed capacitance, the curvature K of the interpolated peak and the orientation θ of the interpolated peak indicating contact with a stylus according to an embodiment of the invention.

FIG. 12 is a flow chart illustrating a method of determining what type of contact/interaction is made with a capacitive touch screen according to an embodiment of the invention.

### DETAILED DESCRIPTION

The drawings and description, in general, disclose a method and apparatus of determining the type (e.g. finger, palm, stylus) of interaction made with a capacitive-touch screen. The capacitance sensor with the largest sensed capacitance in a group of neighboring capacitance sensors is first determined. Next, a parametric surface is determined from the value of the largest sensed capacitance and the values of the sensed capacitances in the group of capacitance sensors. From the parametric surface, an interpolated peak capacitance, a curvature K at the interpolated peak and an orientation θ at the interpolated peak are determined. Based on the interpolated peak capacitance, the curvature K and the orientation θ, the type of contact made with the capacitive touch screen may be identified.

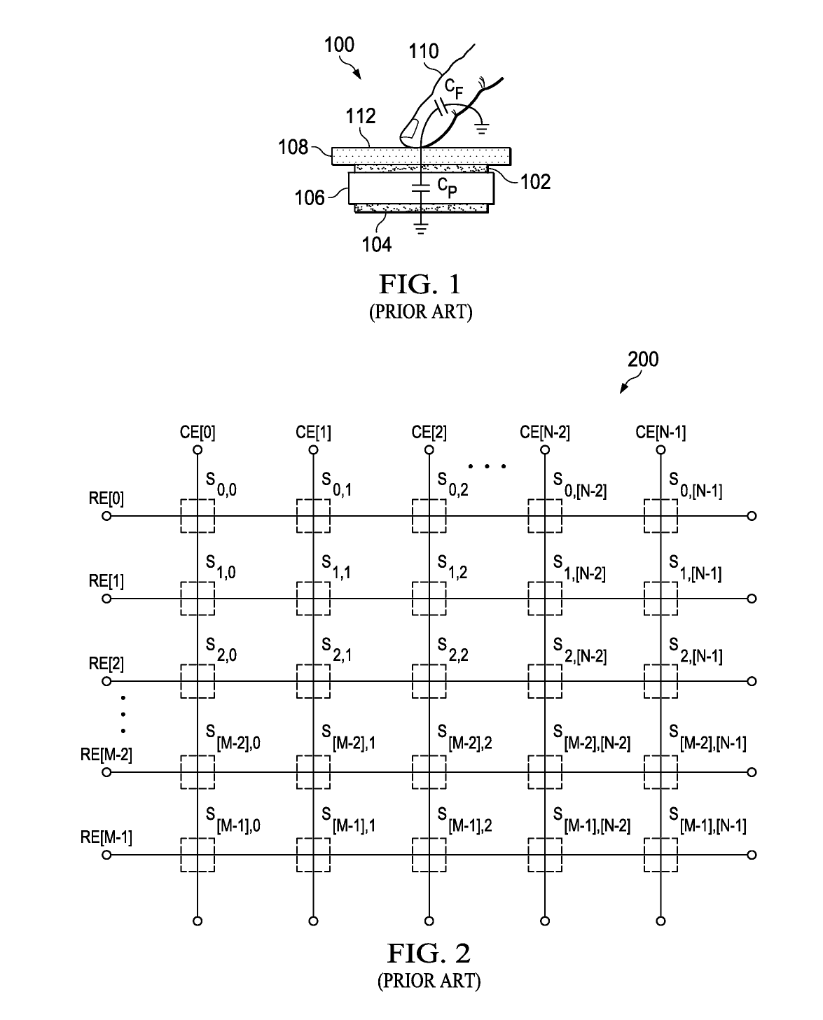

FIG. 1 is a diagram showing a cross-section of a sensor 112 on a capacitive-touch screen 100. Two layers of indium tin dioxide (ITO) electrodes 102 and 104 are laid over an LCD screen 108. A layer of dielectric material (e.g. plastic or pyrex glass) 106 is located between the two layers of electrodes 102 and 104. The baseline capacitance C_{P} and the foreground capacitance C_{F} are also shown.

Consider a capacitive-touch screen as show in FIG. 2 with M row electrodes RE[0]-RE[M-1] and N column electrodes CE[0]-CE[N-1]. The capacitive-touch screen shown in FIG. 2 has M×N capacitance sensors S_{0,0}-S_{[M-1],[N-1]} (nodes) where each sensor has a baseline capacitance C_{P} at the intersection of each column and row electrode. The intersection of each column and row electrode is denoted with a dashed square in FIG. 2. At the intersection of column and row electrodes, electrodes are not directly connected (i.e. they are not shorted to each other). A finger 110 (other objects other than a finger may be used such as a stylus) close to a sensor shunts a portion of the electrical field to ground, which is equivalent to adding a foreground capacitance C_{F} in parallel with C_{P}. Therefore, the sensed capacitance on the node becomes:

C_{S}=C_{P}+C_{F} equ. 1)

Each sensor S_{0,0}-S_{[M-1],[N-1]} on the capacitive-touch screen 200 can be viewed as a pixel in an image. After calibrating the baseline capacitance C_{P} out of C_{S}, the remaining foreground capacitance C_{F} on each node effectively constitutes a two dimensional image of touches or contact made with the capacitive-touch screen 200. Touches may be detected as peaks in the image with properties such as finger size, shape, orientation and pressure as reflected in the shapes of the peaks.

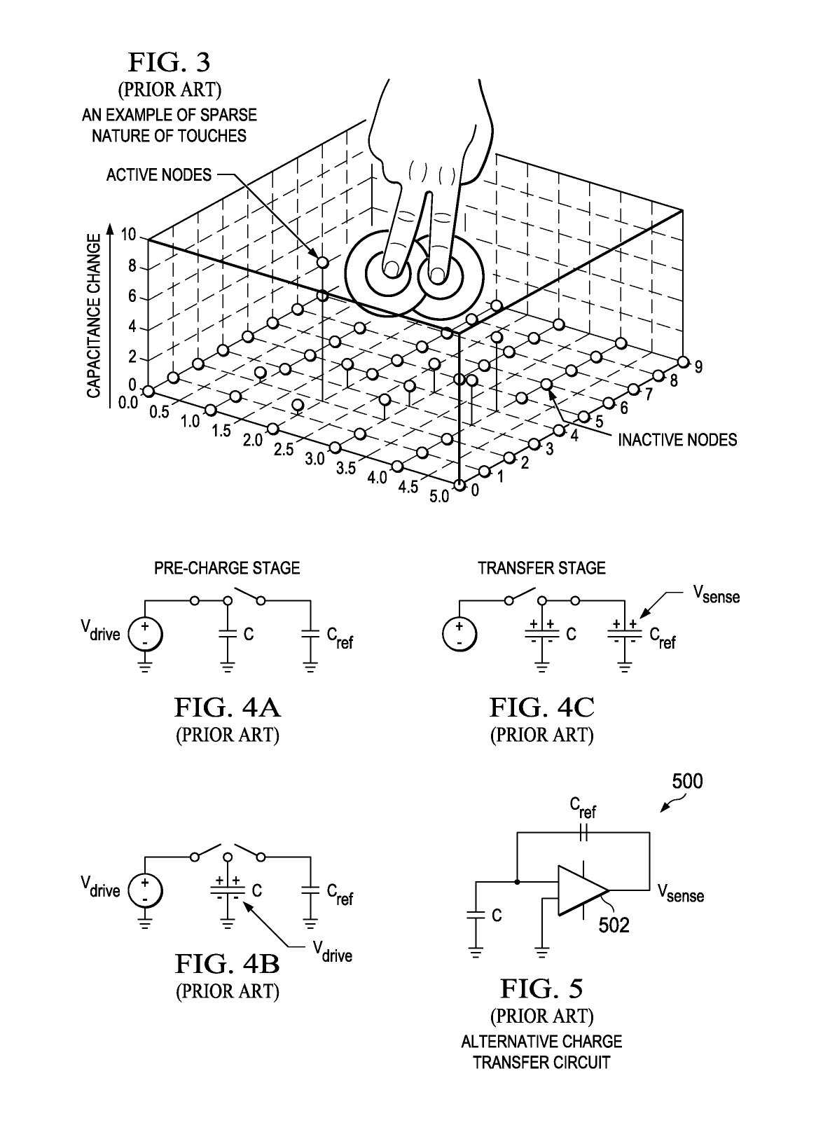

FIG. 3 is a graph of change in capacitance on a sensor as result of two fingers making contact with a capacitive-touch screen. FIG. 3 illustrates that the capacitance of a sensor changes where contact is made with the two fingers (i.e. active nodes). In this example, the number of untouched sensors (i.e. inactive nodes) is significantly greater than the number of touched sensors (i.e. active nodes).

FIGS. 4a-4c are schematic diagrams of a charge transfer technique. As shown in FIGS. 4a-4c, charge transfer is realized in two stages: the pre-charge stage and the transfer stage. In the pre-charge stage as shown in FIG. 4a, the capacitor C is charged with a known voltage source V_{drive} such that in the steady state the charge Q is equal to Q=(V_{drive}*C) as shown in FIG. 4b. In the transfer stage, FIG. 4c, a reference capacitor C_{ref} is connected in parallel with C such that charge on C is transferred onto C_{ref}. The voltage on C_{ref} is Vₛₑₙₛₑ. According to law of conservation of total charge, we have:

V_{drive}*C=Vₛₑₙₛₑ(C+C_{ref}) equ. 2)

which can be rearranged as:

Vₛₑₙₛₑ=C/(C+C_{ref})*V_{drive} equ. 3)

In this case because C_{ref}>>C, we have:

Vₛₑₙₛₑ=(C/C_{ref})*V_{drive} equ. 4)

Equation 4 makes it possible to estimate the capacitance of a sensor C as a proportional relationship between the drive voltage V_{drive}, the sense voltage Vₛₑₙₛₑ and reference capacitance C_{ref}. In an embodiment of the invention, this relationship is used, along with others, to determine where contact is made on a capacitive-touch screen.

An alternative method for using charge transfer to determine the capacitance of a sensor is shown in FIG. 5. An operational amplifier 502 is utilized and the polarity of Vₛₑₙₛₑ is inverted. This method for using charge transfer to determine the capacitance of a sensor also provides a proportionality relationship between the drive voltage V_{drive}, the sense voltage Vₛₑₙₛₑ and capacitance C:

Vₛₑₙₛₑ=gCV_{drive} wherein g is a constant. equ. 5)

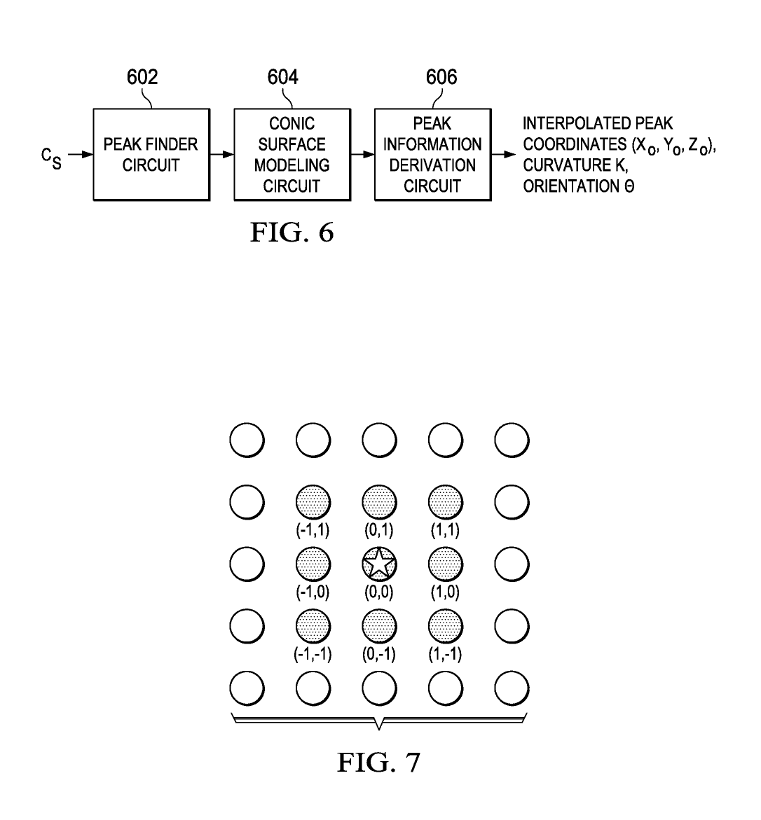

FIG. 6 is a block diagram of an electronic device used to identify the type of contact made with a capacitive-touch screen. The sensed capacitances C_{S} of a group of capacitance sensors is measured by the peak finder circuit 602. The peak finder circuit 602 determines the capacitance sensor with the largest or “peak” capacitance C_{S} from the group of capacitance sensors. FIG. 7 illustrates an example of a group of nine capacitance sensors where the peak capacitance is located at the center coordinate (0,0) of the eight adjacent capacitance sensors located at coordinates (−1, −1), (0, −1), (1,−1), (−1, 0), (1,0), (−1, 1), (0,1) and (1,1). In this example, all of the adjacent capacitance sensors have a smaller sensed capacitance than the capacitive senor located at coordinate (0, 0). When the peak capacitance CS at coordinate (0, 0) from the group of capacitance sensors is determined, the peak capacitance and the capacitances of its eight adjacent neighbors located at coordinates (−1, −1), (0, −1), (1,−1), (−1, 0), (1,0), (−1, 1), (0,1) and (1,1) are passed into the conic surface modeling circuit 604.

The conic surface modeling circuit determines a parametric surface given by the following equation:

f(x,y)=Ax²+Bxy+Cy²+Dx+Ey+F. equ. 1

The relative coordinate of each capacitance sensor shown in FIG. 7 can be labeled with a capacitance sensor location (xᵢ, yᵢ) and sensed capacitance zᵢ. Combining equation 1 and the capacitance sensors locations (xᵢ, yᵢ) and the capacitance zᵢ, the following equation may be obtained:

$$\underbrace{[ \begin{matrix}{x}_{i}^{2} & {x}_{i} {y}_{i} & {y}_{i}^{2} & {x}_{i} & {y}_{i} & 1\end{matrix} ]}_{A} \underbrace{[ \begin{matrix}A \\ B \\ C \\ D \\ E \\ F\end{matrix} ]}_{x} = z , \qquad Equ . 2$$

In this example where there are nine capacitance sensors in a group, a linear equation with nine equations and six variables (i.e. A, B, C, D, E and F) may be written. A least-square estimate of x is performed to solve this over-determined system of linear equations. The least-square estimate is given by the following equation:

x=(A^{T}A)⁻¹A^{T}z. equ. 3

In this example since there are six variables, only values for six capacitance sensors (nodes) are required to fit a surface model. Fitting the surface model with more than 6 nodes (e.g. nine nodes) adds more information that may be used to smooth out noise obtained in the measurements of the sensed capacitances C_{S}. As result, an embodiment of this invention may be used to extend the range of nodes used for fitting the parametric surface. Adding more nodes than the minimum required improves the accuracy of the parametic surface. However, adding more nodes than the minimum requires more computation time as compared to the case where the minimum number of nodes are used.

In an embodiment of the invention where the number and configuration of nodes used is fixed, the value of A in equation 2 is also fixed. As a consequence, the value of (A^{T}A)⁻¹A^{T} does not need to be calculated for each group of measurements. Because the value of (A^{T}A)⁻¹A^{T} is constant in this example and does not need to be calculated for each group of measurements, the computation time required to derive the surface parameters may be reduced. As a result, the matrix (A^{T}A)⁻¹A^{T} may be multiplied by z to derive the surface parameters.

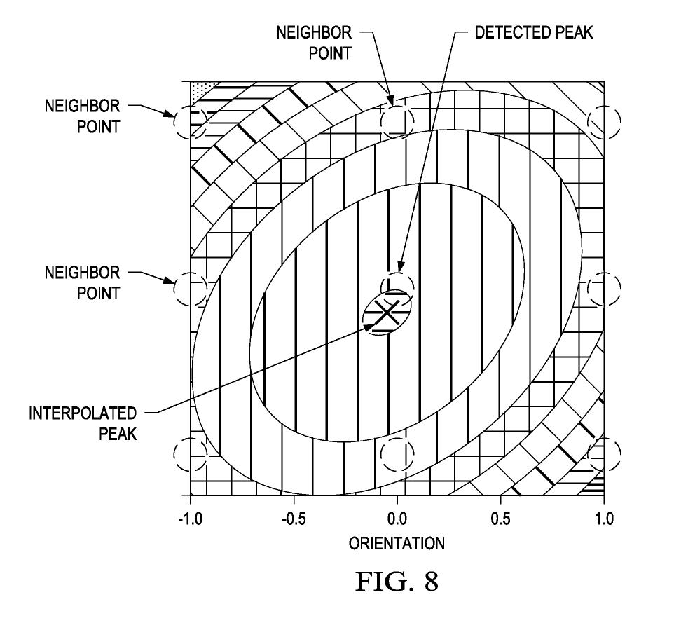

After the conic surface modeling circuit 604 determines the surface parameters, the peak information derivation circuit 606 determines the interpolated peak capacitance coordinates, a curvature K at the interpolated peak capacitance and an orientation θ at the interpolated peak capacitance. FIG. 8 is an example of a conic surface map showing an interpolated peak sensed capacitance, the curvature K of the interpolated peak and the orientation θ of the interpolated peak.

After the surface parameters are determined, the peak coordinates (x₀, y₀, z₀) of the interpolated peak sensed capacitance may be determined by solving the following equations:

$$\begin{matrix}[ \begin{matrix}2 A & B \\ B & 2 C\end{matrix} ] [ \begin{matrix}{x}_{0} \\ {y}_{0}\end{matrix} ] = [ \begin{matrix}- D \\ - E\end{matrix} ] ; & equ . 4 \\ z = {Ax}_{0}^{2} + {Bx}_{0} {y}_{0} + {Cy}_{0}^{2} + {Dx}_{0} + {Ey}_{0} + F . & equ . 5\end{matrix}$$

The curvature at the interpolated peak sensed capacitance may be determined by solving the following equation:

K=4AC−B². equ. 6

The orientation θ at the interpolated peak sensed capacitance may be determined by solving the following equation:

$$tan ( 2 θ ) = \frac{B}{C - A} . \qquad equ . 7$$

Equations 4-7 may be realized in hardware implementations as part of an integrated circuit.

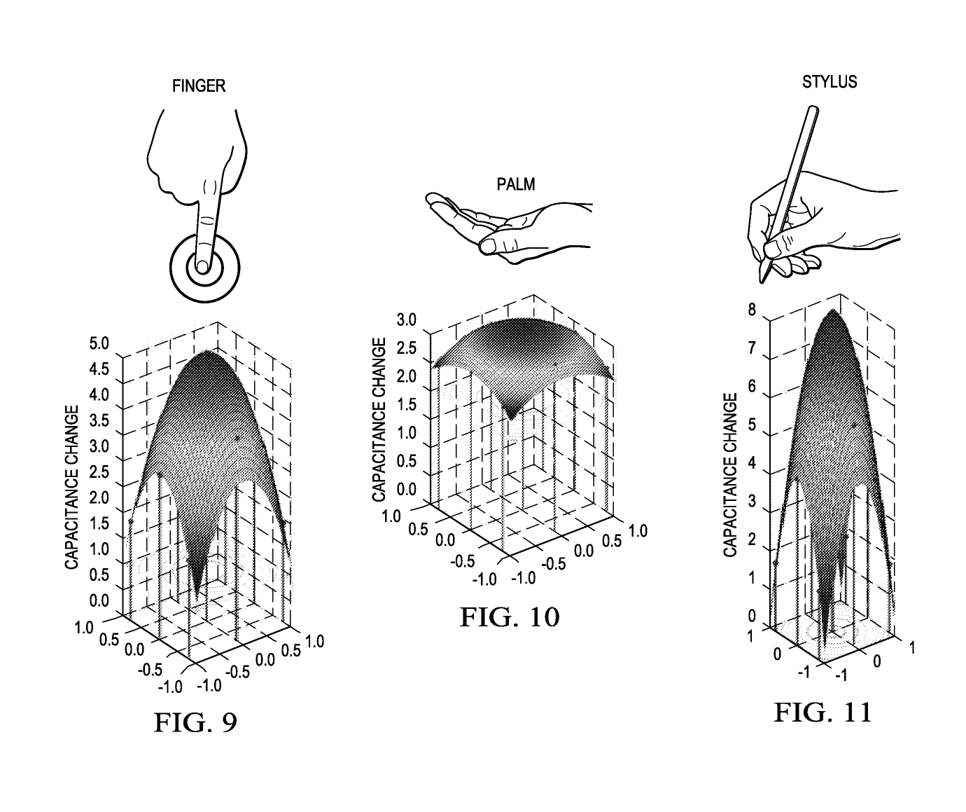

FIG. 9 is an example of a parametric surface showing an interpolated peak sensed capacitance, the curvature K of the interpolated peak and the orientation θ of the interpolated peak indicating contact with a human finger according to an embodiment of the invention. The interpolated peak sensed capacitance in this example is relatively large in magnitude with a relatively steep slope (i.e. curvature K).

FIG. 10 is an example of a parametric surface showing an interpolated peak sensed capacitance, the curvature K of the interpolated peak and the orientation θ of the interpolated peak indicating interaction with a human palm according to an embodiment of the invention. The interpolated peak sensed capacitance in this example is relatively small in magnitude with a relatively shallow slope (i.e. curvature K).

FIG. 11 is an example of a parametric surface showing an interpolated peak sensed capacitance, the curvature K of the interpolated peak and the orientation θ of the interpolated peak indicating contact with a stylus according to an embodiment of the invention. The interpolated peak sensed capacitance in this example is relatively large in magnitude with a very steep slope (i.e. curvature K).

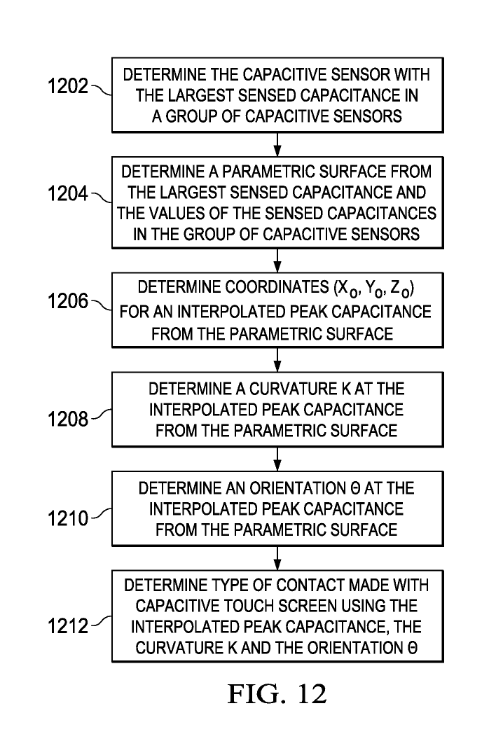

FIG. 12 is a flow chart illustrating a method of determining what type of contact/interaction is made with a capacitive-touch screen according to an embodiment of the invention. During step 1202, the sensed capacitance of each sensor in a group of sensors is measured. They may be measured as previously described or by using other methods. After the sensed capacitance of each sensor is measured, the capacitance sensor with the largest sensed capacitance is determined. During step 1204 the measured value of the largest sensed capacitance and the measured values of the other capacitance sensors in the group are used to determine a parametric surface.

From the parametric surface, the coordinates (x₀,y₀,z₀) for an interpolated peak capacitance are determined as shown in step 1206. During step 1208 the curvature K at the interpolated peak capacitance is determined from the parametric surface. The orientation θ at the interpolated peak capacitance is determined from the parametric surface during step 1210. After the coordinates (x₀,y₀,z₀) for the interpolated peak capacitance, the curvature K at the interpolated peak capacitance and the orientation θ at the interpolated peak capacitance are determined, the type of contact made with the capacitive touch screen can be determined. For example, it may be determined whether contact/interaction with capacitive touch screen is a human finger, a human palm or a stylus.

The foregoing description has been presented for purposes of illustration and description. It is not intended to be exhaustive or to limit the invention to the precise form disclosed, and other modifications and variations may be possible in light of the above teachings. The embodiments were chosen and described in order to best explain the applicable principles and their practical application to thereby enable others skilled in the art to best utilize various embodiments and various modifications as are suited to the particular use contemplated. It is intended that the appended claims be construed to include other alternative embodiments except insofar as limited by the prior art.

What is claimed is:

1. A machine-implemented method of determining a type of interaction made with capacitive-touch screen comprising:
determining, using an electronic device, the capacitance sensor with the largest sensed capacitance in a group of capacitance sensors, wherein the group of capacitance sensors are located on the capacitive-touch screen; wherein the capacitive-touch screen is located on an electronic device;
determining a parametric surface from the value of the largest sensed capacitance and the values of the sensed capacitances in the group of capacitance sensors;
determining coordinates (x₀, y₀, z₀) for an interpolated peak capacitance from the parametric surface,
determining a curvature K at the interpolated peak from the parametric surface; and
determining an orientation θ at the interpolated peak capacitance from the parametric surface;
wherein the type of interaction made with the capacitive-touch screen is determined by the interpolated peak capacitance, the curvature K and the orientation θ.

2. The method of claim 1 wherein the group of capacitance sensors comprises 9 capacitance sensors wherein the capacitance sensor with the largest sensed capacitance is adjacent to all 8 other capacitance sensors and all 8 other capacitance sensors have smaller sensed capacitances than the capacitance sensor with the largest capacitance.

3. The method of claim 1 wherein the type of interaction made with the capacitive-touch screen is a human palm when the magnitude of the interpolated peak capacitance is relatively low and the curvature K at the interpolated peak is relatively low.

4. The method of claim 1 wherein the type of interaction made with the capacitive-touch screen is a human finger when the magnitude of the interpolated peak capacitance is relatively high and the curvature K at the interpolated peak is relatively moderate.

5. The method of claim 1 wherein the type of interaction made with the capacitive-touch screen is a stylus when the magnitude of the interpolated peak capacitance is relatively high and the curvature K at the interpolated peak is relatively high.

6. The method of claim 1 wherein the parametric surface is defined by the following equation:
f(x,y)=Ax²+Bxy+Cy²+Dx+Ey+F.

7. The method of claim 1 wherein the coordinates (x₀, y₀, z₀) for an interpolated peak capacitance from the parametric surface can be calculated by solving the following equations:
$$[ \begin{matrix}2 A & B \\ B & 2 C\end{matrix} ] [ \begin{matrix}{x}_{0} \\ {y}_{0}\end{matrix} ] = [ \begin{matrix}- D \\ - E\end{matrix} ]$$
$$z = {Ax}_{0}^{2} + {Bx}_{0} {y}_{0} + {Cy}_{0}^{2} + {Dx}_{0} + {Ey}_{0} + F .$$

8. The method of claim 1 wherein the curvature K at the peak of the parametric surface is defined by the following equation:
K=4AC−B².

9. The method of claim 1 wherein the orientation θ at the peak of the parametric surface is defined by the following equation:
$$tan ( 2 θ ) = \frac{B}{C - A} .$$

10. The method of claim 1 wherein the electronic device is selected from a group consisting of a cellular phone, a hand-held personal computer, a tablet personal computer, a portable personal computer, a monitor and a television.

11. An electronic device comprising:
a peak finding circuit configured to determine a capacitance sensor with the largest sensed capacitance in a group of capacitance sensors, wherein the group of capacitance sensors are located on a capacitive-touch screen; wherein the capacitive-touch screen is located on the electronic device;
a conic surface modeling circuit to determine a parametric surface from the value of the largest sensed capacitance and the values of the sensed capacitances in the group of capacitance sensors;
a peak information derivation circuit to determine coordinates (x₀, y₀, z₀) for an interpolated peak capacitance from the parametric surface, a curvature K at the interpolated peak capacitance from the parametric surface and an orientation θ at the interpolated peak capacitance from the parametric surface;
wherein the type of interaction made with the capacitance-touch screen is determined by the interpolated peak capacitance, the curvature K and the orientation θ.

12. The electronic device of claim 11 wherein the group of capacitance sensors comprises 9 capacitance sensors wherein the capacitance sensor with the largest sensed capacitance is adjacent to all 8 other capacitance sensors and all 8 other capacitance sensors have smaller sensed capacitances than the capacitance sensor with the largest capacitance.

13. The electronic device of claim 11 wherein the type of interaction made with the capacitive-touch screen is a human palm when the magnitude of the interpolated peak capacitance is relatively low and the curvature K at the interpolated peak is relatively low.

14. The electronic device of claim 11 wherein the type of interaction made with the capacitive touch screen is a human finger when the magnitude of the interpolated peak capacitance is relatively high and the curvature K at the interpolated peak is relatively moderate.

15. The electronic device of claim 11 wherein the type of interaction made with the capacitive touch screen is a stylus when the magnitude of the interpolated peak capacitance is relatively high and the curvature K at the interpolated peak is relatively high.

16. The electronic device of claim 11 wherein the parametric surface is defined by the following equation:
f(x,y)=Ax²+Bxy+Cy²+Dx+Ey+F.

17. The electronic device of claim 11 wherein the coordinates (x₀, y₀, z₀) for an interpolated peak capacitance from the parametric surface can be calculated by solving the following equations:
$$[ \begin{matrix}2 A & B \\ B & 2 C\end{matrix} ] [ \begin{matrix}{x}_{0} \\ {y}_{0}\end{matrix} ] = [ \begin{matrix}- D \\ - E\end{matrix} ]$$
$$z = {Ax}_{0}^{2} + {Bx}_{0} {y}_{0} + {Cy}_{0}^{2} + {Dx}_{0} + {Ey}_{0} + F .$$

18. The electronic device of claim 11 wherein the curvature K at the peak of the parametric surface is defined by the following equation:
K=4AC−B².

19. The electronic device of claim 11 wherein the orientation θ at the peak of the parametric surface is defined by the following equation:
$$tan ( 2 θ ) = \frac{B}{C - A} .$$

20. The electronic device of claim 11 wherein the electronic device is selected from a group consisting of a cellular phone, a hand-held personal computer, a tablet personal computer, a portable personal computer, a monitor and a television.

21. The electronic device of claim 11 wherein the peak finding circuit, the conic surface modeling circuit and the peak information derivation circuit are located on the same integrated circuit.
